(19) United States
(12) Patent Application Publication
(10) Pub. No.: US 2014/0068522 A1
(43) Pub. Date: Mar. 6, 2014

(54) TERMINAL AND METHOD FOR DISPLAYING OPERABILITY OF AN APPLICATION

(71) Applicant: Pantech Co., Ltd., Seoul (KR)

(72) Inventors: Hea Yeon LIM, Seoul (KR); Sung Hun Cha, Seoul (KR)

(73) Assignee: Pantech Co., Ltd., Seoul (KR)

(21) Appl. No.: 13/972,495

(22) Filed: Aug. 21, 2013

(30) Foreign Application Priority Data
Aug. 30, 2012 (KR) 10-2012-0095544

(51) Int. Cl. G06F 3/0481

(52) U.S. Cl. CPC G06F 3/04817
USPC 715/846

(57) ABSTRACT

Provided is a terminal that displays the operability of an application including: a storage unit storing precondition information of the application relating to usage environment; a determination unit comparing the stored precondition information of the application and the current state information of the terminal, determining whether the application is normally operable; applying a visual effect based on the determination to an icon corresponding to the application; and displaying the visually affected icon. Accordingly, a user can intuitively check the status of the application desired to be executed, whereby the user convenience can be improved.

### CROSS-REFERENCE TO RELATED APPLICATIONS

This application claims the benefit of and priority under 35 U.S.C. §119 to Korean Patent Application No. 10-2012-0095544, filed on Aug. 30, 2012, in the Korean Intellectual Property Office, the disclosure of which is incorporated herein by reference in its entirety.

### BACKGROUND

1. Field

The following disclosure relates to a terminal and a method for displaying the status of an application, and in particular, to displaying a status for visually recognizing whether an application can be operated normally prior to the execution of the application.

2. Discussion of the Background

Recently, various applications are executed by users in accordance with the wide use of smartphones. In using a smartphone, the usage environment available to applications of the smartphone frequently changes in accordance with user's intention or external environmental factors. An example of a usage environment includes, for example, a communication environment of a terminal including a network connection type availability.

For example, in a case where a user sets the GPS or the 3G communication to an inactive state, an application using the GPS or the 3G communication may not be executed. In addition, in a case where a user moves in the state in which a WIFI connection is used in a smartphone and is out of the range of a WIFI access point, the WIFI connection is disconnected.

In such a case, when the user forgets to have set the GPS or the 3G communication to the inactive state or does not recognize to be out of the range of the WIFI access point and executes an application using the corresponding network, the application is driven but does not operate normally due to no network connection.

Currently, in smartphones, since icons used for executing applications are uniformly arranged on the screen, whether each application can be operated in accordance with the current environment of the smartphones is not displayed. Accordingly, in the case of an application that can operate based on a network connection, before the user directly executes the application and recognizes a problem in the network connection, there is no way for checking the restriction of the operation of the application according to the environment of the smartphone, which causes inconvenience.

Consequently, although a user has searched for a desired application from among many applications installed to the smartphone and executed the application, the user needs to execute the application again after setting the state or usage environment of the smartphone to match the environment needed to execute the application, which causes inconvenience.

### SUMMARY

Exemplary embodiments of the present invention provide for displaying the status of an application, where the status conveys whether an application can be operated normally before the execution of the application.

Additional features of the invention will be set forth in the description that follows, and in part will be apparent from the description, or may be learned by practice of the invention.

According to exemplary embodiments, there is provided a terminal that displays the operability of an application, the terminal including: a storage unit configured to store precondition information of the application relating to a usage environment; a determination unit configured to compare the stored precondition information of the application to a current state information of the terminal, configured to determine whether the application is normally operable, and configured to apply a visual effect based on the determination to an icon corresponding to the application; and a display unit configured to display the visually affected icon.

According to exemplary embodiments, there is provided a method for displaying the operability of an application, the method including: storing precondition information of the application relating to a usage environment; comparing the stored precondition information of the application to a current state information of the terminal; determining whether the application is normally operable; applying a visual effect based on the determination to an icon corresponding to the application; and displaying the visually affected icon.

According to exemplary embodiments, there is provided a computer-implemented method to display the operability of an application, the method including: storing, in a non-transitory storage, an operating environment precondition of the application; comparing, with a processor, a current operating environment of a terminal with the operating environment precondition to determine the operating environment precondition that is unsatisfied by the current operating environment; selecting a visual effect to represent the unsatisfied operating environment precondition; applying the visual effect to an icon corresponding to the application; and displaying, with processor, the visually affected icon.

According to the terminal and the method for displaying the status of an application, the status displays whether the application can be operated normally based on the current usage environment of the terminal, and accordingly, the status of the application can be displayed before the execution of the application.

According to exemplary embodiments, an auxiliary icon displaying precondition information of the usage environment of the application can be displayed with the application status and the user can recognize the environmental preconditions ideal or needed for an application to be executed.

Therefore, the user can check the status of an application and change the usage environment of the terminal accordingly, if possible. By checking the status prior to application execution, unnecessary operations by a user can be reduced.

Furthermore, convenience of using the terminal can be improved. When an application to be executed by a user cannot be operate normally, an interface for changing the usage environment of the terminal to conform to the ideal preconditions for execution of the application is provided.

It is to be understood that both the forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The above and other objects, features and advantages of the present disclosure will become apparent from the following description of certain exemplary embodiments given in conjunction with the accompanying drawings. The accompanying drawings provide a further understanding of the invention and are incorporated in and constitute a part of this specification, illustrate embodiments of the invention, and together with the description serve to explain the principles of the invention.

FIG. 1 illustrates a terminal for displaying the status of an application, according to exemplary embodiments of the present disclosure.

FIG. 2 illustrates a screen that is displayed on a display unit of a terminal, according to exemplary embodiments of the present disclosure.

FIG. 3 illustrates a method of displaying the status of an application, according to exemplary embodiments of the present disclosure.

FIG. 4A to 8B illustrate screens displayed on a display unit of a terminal, according to exemplary embodiments of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Hereinafter, a terminal and a method for displaying the status of an application according to embodiments will be described in detail with reference to the drawings.

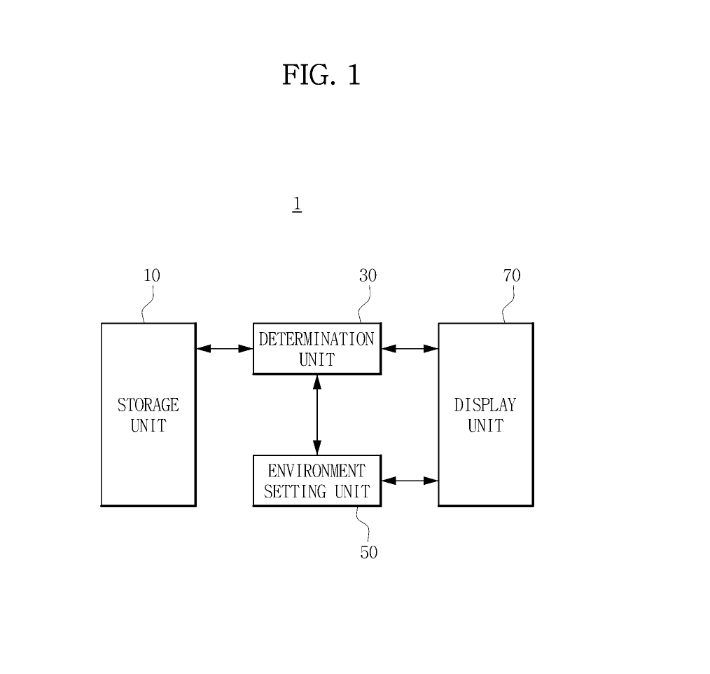

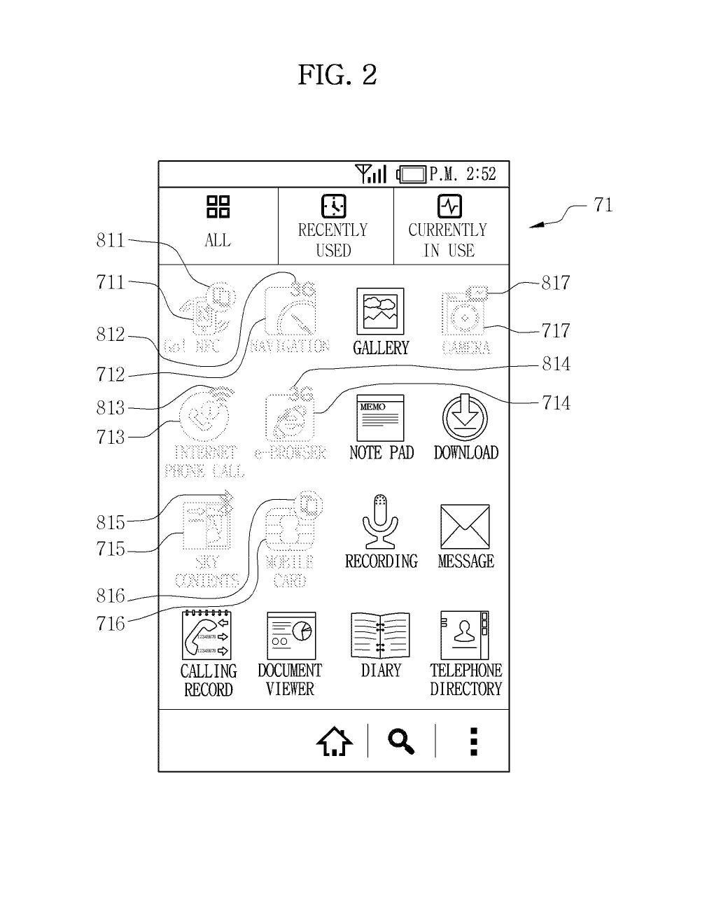

FIG. 1 illustrates a terminal for displaying the status of an application, according to exemplary embodiments of the present disclosure. FIG. 2 illustrates a screen that is displayed on a display unit of a terminal, according to exemplary embodiments of the present disclosure.

As illustrated in FIG. 1, terminal 1 can include a storage unit 10, a determination unit 30, and a display unit 70. The terminal 1 may further include an environment setting unit 50.

The terminal 1 may include a mobile device, such as, a smartphone, a tablet computer, a netbook, a PDA, a PMP, a PSP, an MP3 player, an e-book reader, a navigation device, a smart camera, an electronic dictionary, an electronic watch, and the like. The terminal 1 may include an electronic device, such as, a desktop computer, a smart television set, a wired/wireless phone, a smart door lock, and the like. For example, the terminal 1 may be a touch-screen type smartphone that receives information by sensing a touch from a user's hand, a touch pen, or the like on the display unit 70.

The terminal 1 may execute various application programs based on an Operating System (OS), and the operating system may include any operating system that can be disposed in a terminal, such as, ANDROID OS, IOS produced by Apple Inc., a WINDOWS MOBILE OS, a BADA OS, a SYMBIAN OS, a BLACKBERRY OS, and the like.

The storage unit 10 can include a collection of precondition information of applications relating to the usage environment of the terminal. The collection can store information for applications installed on the terminal 1. The storage unit 10 can store precondition information for describing an environment ideal for application use. The applications may be installed by the manufacturer of the terminal, or may be downloaded by a user from an application market or the like, and be installed.

The applications are programs developed for executing specific operations and may include application programs, multimedia content, such as, a game, a motion picture, or a photograph, or an execution program that reproduces the multimedia contents, such as, a camera, an image viewer, or a motion picture player.

The precondition information of an application can be collected by parsing metadata of the application, for example, by the terminal 1. In some embodiments, the metadata can be provided to the terminal 1 by a provider of the application, for example, by the application market or the terminal manufacturer. The metadata includes attribute information of the application. Attribute information is data assigned to contents according to a rule for efficiently searching for desired information from among a large quantity of information and using the desired information. For example, in the metadata, the usage environment, the location, the subject matter of contents, author information, right preconditions, use preconditions, use histories, and the like of an application can be recorded.

The determination unit 30 determines whether applications can be normally or ideally operated by comparing the stored precondition information of the application to the usage environment. When application icons representing applications are displayed, for example, on a home menu or the like, the determination unit 30 queries the information of the applications from the storage unit 10.

The home menu is a screen on which icons of applications are arranged to perform specific functions in the terminal 1. The functionality of the home menu includes an application launcher.

The determination unit 30 queries information relating to an application's preconditions of use to the use and determines what usage environment is requested or required by the application. When an application does not have preconditions relating to the usage environment, a basic icon of the application is displayed without alteration in a conventional manner.

On the other hand, when an application has the preconditions relating to the usage environment, the determination unit 30 compares the stored precondition information of the application relating to the usage environment and the current state information of the terminal 1 relating to the usage environment with each other, and determines whether the application can be operated normally.

When the current state of the terminal 1 relating to the usage environment satisfies the preconditions of the application relating to the usage environment, the determination unit 30 determines that the application can be normally operated. On the other hand, when the current state of the terminal 1 relating to the usage environment does not satisfy the preconditions of the application relating to the usage environment, the determination unit 30 determines that the application cannot be normally operated. Thereafter, when the usage environment of the terminal 1 changes, for example, due to user's setting, a change in the external environment, or the like, the determination unit 30 updates the determination of whether the application can be normally operated.

The usage environment can include a communication environment of the terminal, an update environment of the application, a functional environment of the terminal, and the like.

For example, the communication environment of the terminal can include availability or enabling of various communication technologies, for example, 3G/4G, WIFI, Near Field Communication (NFC), BLUETOOTH, and the like.

For example, an application providing a navigation function or an application providing a social networking service (SNS), and the like can be executed only in the state of being connected to a network, such as, 3G/4G or WIFI. In other words, ability to connect to a network, such as, 3G/4G or WIFI is a precondition of the application.

In addition, the update environment of an application can include an update/no-update precondition for the application. Depending on an application, the existing version of the application may or may not be executable without the completion of an update.

The functional environment of an application can include a usability/no-usability precondition for an application. For example, a camera application, a camera application linked with a social networking service (SNS), and the like may only be executable when the camera of the terminal 1 can be used, and when the camera is locked or cannot be used for any reason, the application may not be executable. In other words, the usability of the camera is a precondition of the application relating to the usage environment.

Based on a determination made by the determination unit 30 whether the application can be normally operated, the display unit 70 displays the icon of the application with a visual effect being applied thereto.

An icon according to the present disclosure is an image representation or mark for displaying the function of an application in an understandable and intuitive manner, and may include user interfaces (UI), such as, a widget and a theme.

For example, the icon of the application may be displayed with a visual effect (a visually affected icon) including at least one of a dimming, a monochromatic palette, a sharpness adjustment, a transparency adjustment, a web process, a mosaic process, and the like. For example, the icon may be displayed in colors when the corresponding application can be normally operated, and the icon may be displayed in black and white when the corresponding application cannot be normally operated. In some embodiments, the icon may be displayed using a basic icon when the corresponding application can be normally operated, and the icon may be displayed as a visually affected icon, for example, subject to a semitransparency adjustment, when the corresponding application cannot be normally operated.

The above-described visual effects of the icon are merely examples, and any visual effect that causes a non-operable application icon to be distinguishable from the basic icon of an application may be applied.

In some embodiments, the display unit 70 may combine an auxiliary icon representing the precondition information relating to the usage environment with the icon of the application. The number of auxiliary icons combined with the basic icon may number one, two, or more. The size of the auxiliary icon may be smaller than the icon of the application, and the auxiliary icon may be displayed, for example, along an edge of the basic icon, in a corner of the basic icon, at least one of an upper end, a lower end and a side (edge) of the icon of the application, overlapping the icon of the application, or a combination thereof.

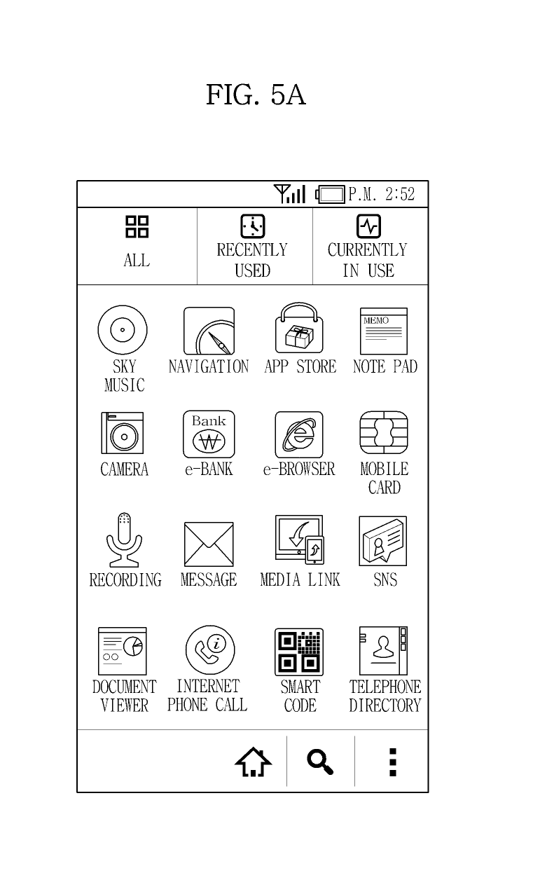

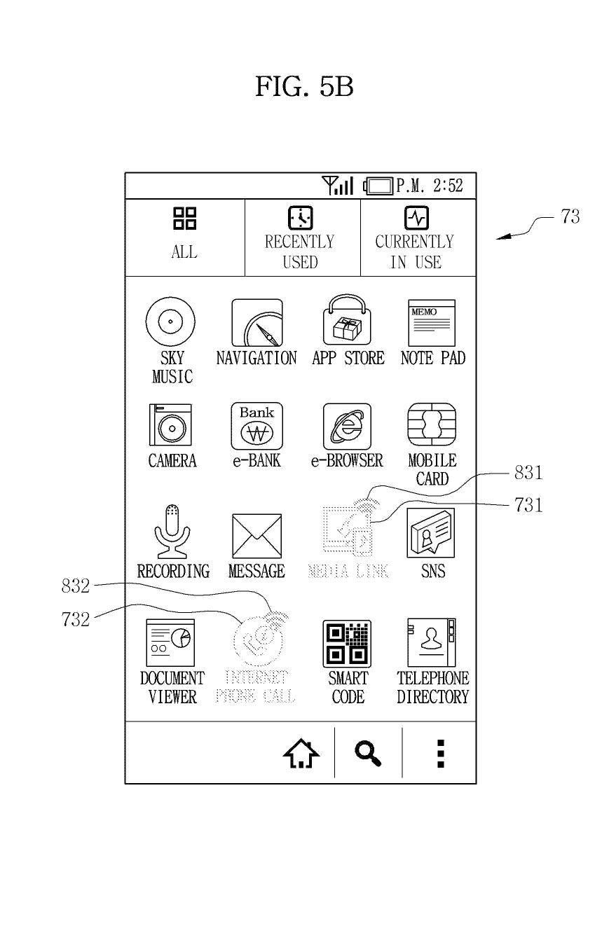

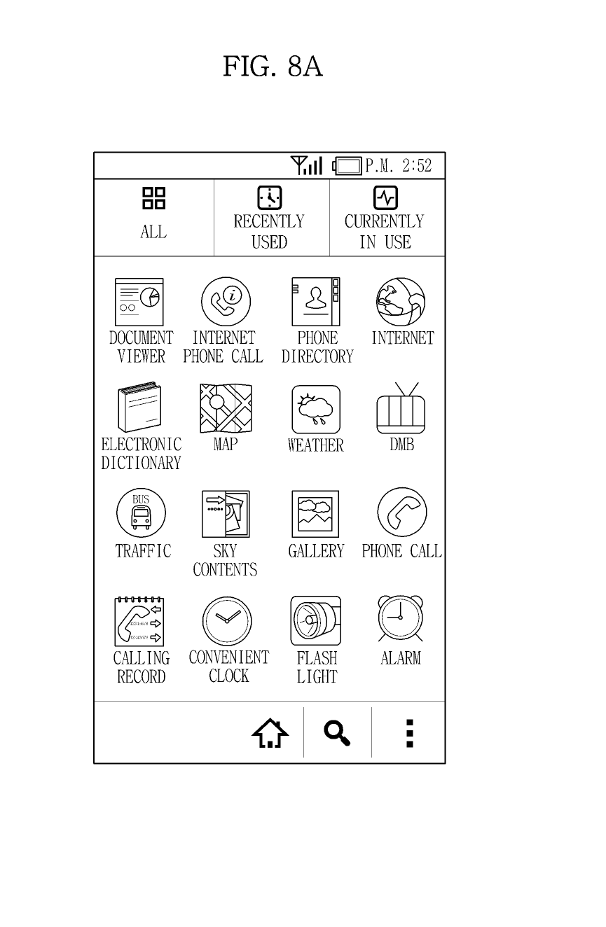

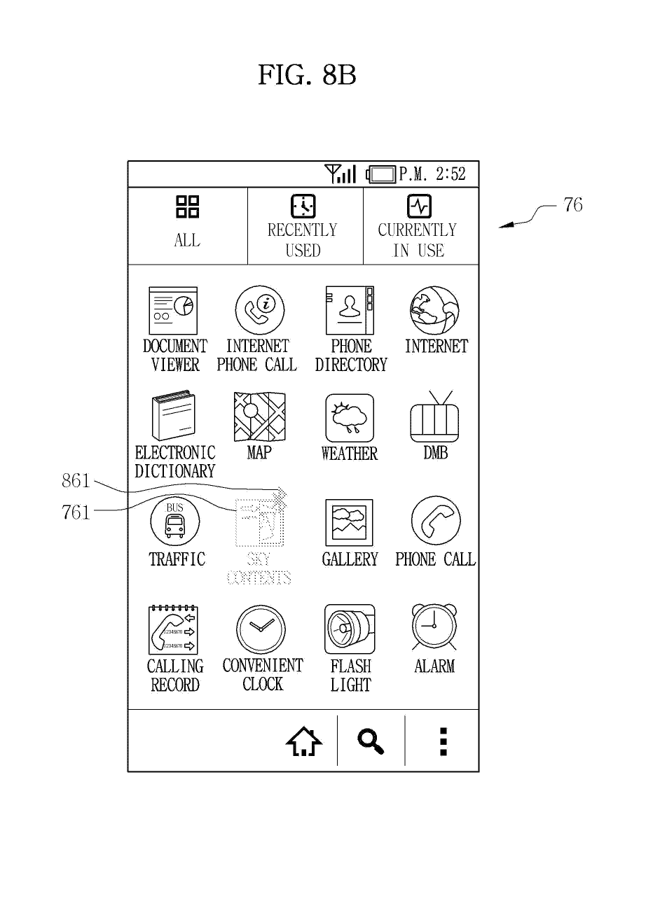

For example, for an application relating to BLUETOOTH, an auxiliary icon (for example, icon 861 of FIG. 8B) representing BLUETOOTH may be displayed in combination with the icon of the application to form a visually affected icon. When a connection to a 3G or WIFI network is necessary, auxiliary icons for, for example, 3G or WIFI (for example, icon 832 of FIG. 5B) may be displayed combined with the basic icon of the application.

The auxiliary icon may be displayed when the corresponding precondition is in the inactive state or not satisfied. For example, in a case where 3G is in the active state, the auxiliary icon representing 3G is not displayed, and the auxiliary icon representing 3G may be displayed only in a case where 3G is in the inactive state. In some embodiments, the auxiliary icon may be displayed when a corresponding precondition is in the active state or is satisfied.

In some embodiments, the auxiliary icon may be configured to be displayed in colors when a corresponding precondition is in the active state, and in black and white when the corresponding precondition is in the inactive state. For example, when WIFI is in the active state, the auxiliary icon representing WIFI may be displayed in color, and when WIFI is in the inactive state, the auxiliary icon representing WIFI may be displayed in black and white. Further, aspects of the invention need not be limited thereto such that the application icon may additionally or individually be displayed in color and in black and white according to the active or inactive state of the precondition.

The usage environment of the terminal 1 may change in accordance with a user's input or an external environmental factor (for example, in the case of getting out of a WIFI AP range). When the usage environment of the terminal 1 changes, the display unit 70 may display whether the application can be normally operated by updating the icon of the application and the auxiliary icon.

By referring to FIG. 2, an example of a screen 71 including visually affected icons on the display unit 70, of FIG. 1, is illustrated in which a dimming process has been performed for icons of applications that cannot be executed, as the preconditions relating to the usage environment are not satisfied.

For example, when NFC cannot be used, a dimming process is performed for icons 711, 716 of applications using NFC, and auxiliary icons 811, 816 representing NFC may be displayed together with the icons 711, 716. In addition, when 3G communications cannot be used, a dimming process is performed for icons 712, 714 of applications using 3G, and auxiliary icons 812, 814 representing 3G communication may be displayed together with the icons 712, 714.

In a case where WIFI cannot be used, a dimming process is performed for an icon 713 of an application using WIFI, and an auxiliary icon 813 representing WIFI may be displayed together with the icon 713. When BLUETOOTH cannot be used, a dimming process is performed for an icon 715 of an application using BLUETOOTH, and an auxiliary icon 815 representing BLUETOOTH may be displayed together with the icon 715. Similarly, in a case where the camera cannot be used, an icon 717 of an application using the camera is processed in black and white, and an auxiliary icon 817 representing the camera may be displayed together with the icon 717.

In exemplary embodiments, the display unit 70 may arrange and display only activated icons, in other words, only icons of applications that can be normally operated are displayed. In such a case, a user can check the applications that can be normally operated more easily.

When there is a request for executing an application that cannot be normally operated in accordance with the precondition, the environment setting unit 50 of FIG. 1 may provide an interface for changing the usage environment of the terminal 1. For example, a pop-up window or a setting screen on which the usage environment can be changed may be used can be provided.

For example, when a user tries to execute an application using WIFI in the inactive state of WIFI, the environment setting unit 50 may provide a window in which the activation of WIFI may be set. In exemplary embodiments, when a user tries to execute an application using a camera in the inactive state of the camera, the environment setting unit 50 may provide a pop-up window in which the activation of the camera may be set.

In a case where the terminal 1 is a touch-screen type device, a user may try to execute an application by touching the icon of the application using a hand, a touch pen, or the like. In some embodiments, a user may try to execute an application by clicking or selecting the icon of the application.

In exemplary embodiments, an icon representing each application visually represents whether the application can be normally operated, and accordingly, the user can instantly recognize the status of the application.

In some embodiments, the auxiliary icon representing the precondition information of the application relating to the usage environment is displayed together, a user can intuitively recognize the precondition of the application desired to be executed. Accordingly, the user can change the usage environment of the terminal in accordance with the precondition of the application before trying to execute the application.

In some embodiments, the user convenience may be improved by providing an interface for changing the usage environment of the terminal where an application desired to be executed by a user cannot be normally operated.

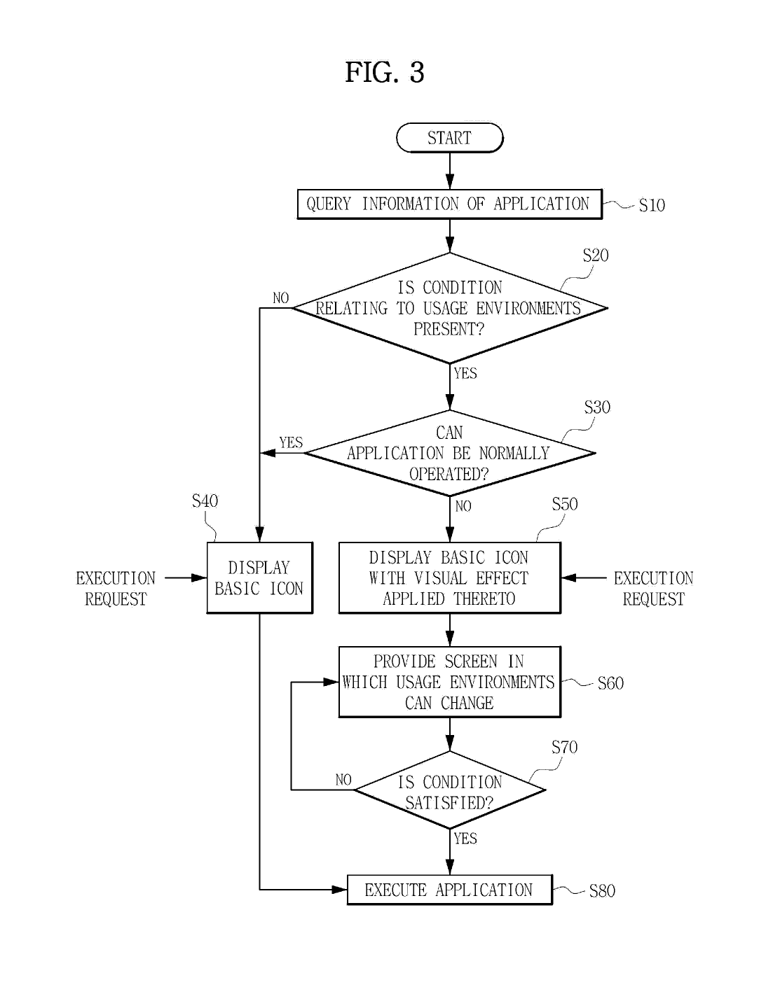

FIG. 3 illustrates a method of displaying the status of an application according to exemplary embodiments of the present disclosure.

The method of displaying the status of an application according to exemplary embodiments may proceed using a configuration that is substantially the same as that of the terminal 1, illustrated in FIG. 1. Thus, the same reference numeral is assigned to constituent elements of the terminal 1, illustrated in FIG. 1, and the description thereof will not be repeated.

In the method of displaying the status of an application, when a user executes a home menu to perform a specific function in the terminal 1, the icons of applications installed to the terminal 1 are displayed on the display unit 70 of the terminal 1. The icons can display whether the applications can be normally operated in accordance with the preconditions relating to the usage environment.

In FIG. 3, when the home menu is executed, the determination unit 30 queries precondition information of the applications relating to the usage environment. The precondition information can be stored in the storage unit 10 (S 10). The storage unit 10 collects and stores the precondition information of the applications installed on the terminal 1.

The determination unit 30 determines whether the preconditions relating to the usage environment is present in each application (S20). A usage environment can include a communication environment, an update environment of the applications, a functional environment, and the like.

When no preconditions relating to a usage environment are present in the stored precondition information for an application (the “NO” branch from S20), the basic icon of the corresponding application is displayed in a conventional manner (S40).

On the other hand, when a precondition relating to a usage environment is present in the stored precondition information for an application (the “YES” branch from S20), the determination unit 30 determines whether the application can be normally operated in accordance with the stored preconditions (S30).

The stored precondition information of the applications relating to the usage environment and the current state information of the terminal 1 relating to the usage environment are compared with each other. When the current state of the terminal 1 relating to the usage environment satisfies the stored precondition of the application relating to the usage environment, the determination unit 30 determines that the application can be normally operated (the “YES” branch from S30). On the other hand, when the current state of the terminal 1 relating to the usage environment does not satisfy the stored precondition of the application relating to the usage environment, the determination unit 30 determines that the application cannot be normally operated (the “NO” branch from S30).

The display unit 70 displays the icons of the applications per S40 and S50. When the application can be normally operated, the basic icon of the application is displayed in a conventional manner (S40). On the other hand, when the application cannot be normally operated, the basic icon of the application is displayed with a visual effect being applied thereto (S50).

The icon is a representation including an image or a mark for displaying the function of an application in an easily-understandable and intuitive manner and may include user interfaces (UI), such as, a widget and a theme.

In some embodiments, the icon of the application may be displayed using a visual effect. The visual effect can include at least one of a dimming process, a monochromatic palette, sharpness adjustment, transparency adjustment, a web process, a mosaic process, and the like. In some embodiments, the icon may be displayed in color when the application can be normally operated and the icon can be displayed in black and white in a case where the corresponding application cannot be normally operated. In some embodiments, the icon may be displayed using the basic icon when the corresponding application can be normally operated and the icon may be displayed with a semitransparent visual effect when the corresponding application cannot be normally operated. The above-described visual effects of the icon are merely examples, and any visual effect that causes the icon to be distinguishable from the basic icon may be applied.

The display unit 70 may display the auxiliary icon representing the precondition information relating to the usage environment together with the icon of the application. The auxiliary icon may visually display whether a corresponding precondition is in the active state or whether the corresponding precondition is in the inactive state.

The number of auxiliary icons displayed may be one, two or more. In some embodiments, the size of the auxiliary icon may be smaller than the icon of the application. In some embodiments, the auxiliary icon may be displayed in the upper end or the lower end of the icon of the application, or be displayed to overlap the icon of the application.

In addition, when the usage environment of the terminal 1 change, the display unit 70 may update and display whether the application can be normally operated in accordance with the precondition.

An icon of an application visually represents whether the application can be normally operated, and accordingly, a user can instantly recognize whether the application can be normally operated. In addition, since the auxiliary icon representing the precondition information of the application relating to the usage environment is displayed together, the user can intuitively recognize the precondition of the application desired to be executed.

In some embodiments, when a user requests to execute an application that cannot be normally operated in accordance with the precondition, an interface for changing the usage environment of the terminal 1 may be further included (S60). By providing the interface for changing the usage environment, the user can change the usage environment for executing the application more easily. For example, a pop-up window or a setting screen on which the usage environment can be changed may be used.

Thereafter, it is determined whether the precondition of the application is satisfied (S70). In a case where the precondition is satisfied in S70, the application is executed (S80) (the “YES” branch of S70). When the precondition is not satisfied in S70, the providing the interface for changing the usage environment is provided to the user (S60) (the “NO” branch of S70).

A user convenience is improved by providing an interface for changing the usage environment of the terminal 1, when an application desired to be executed by a user cannot normally operate.

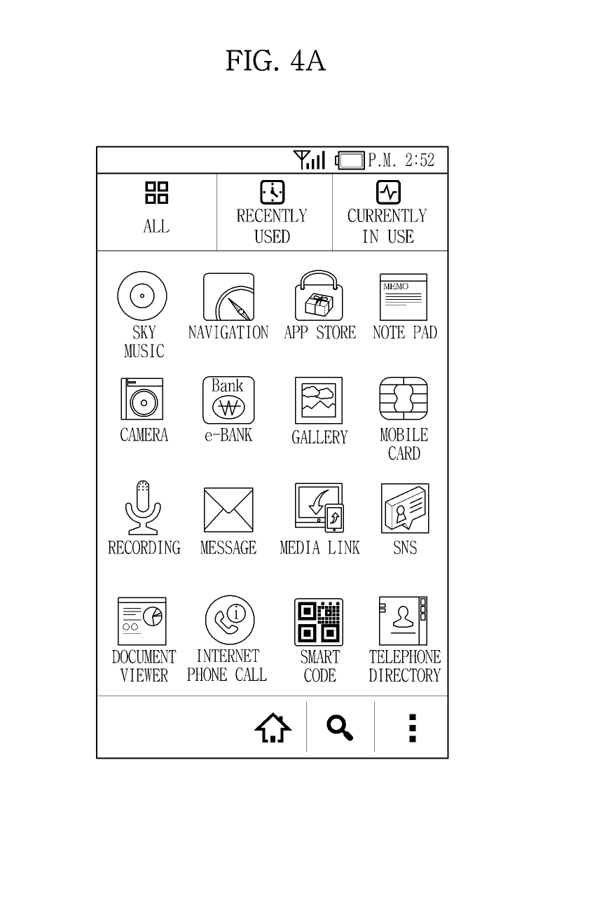

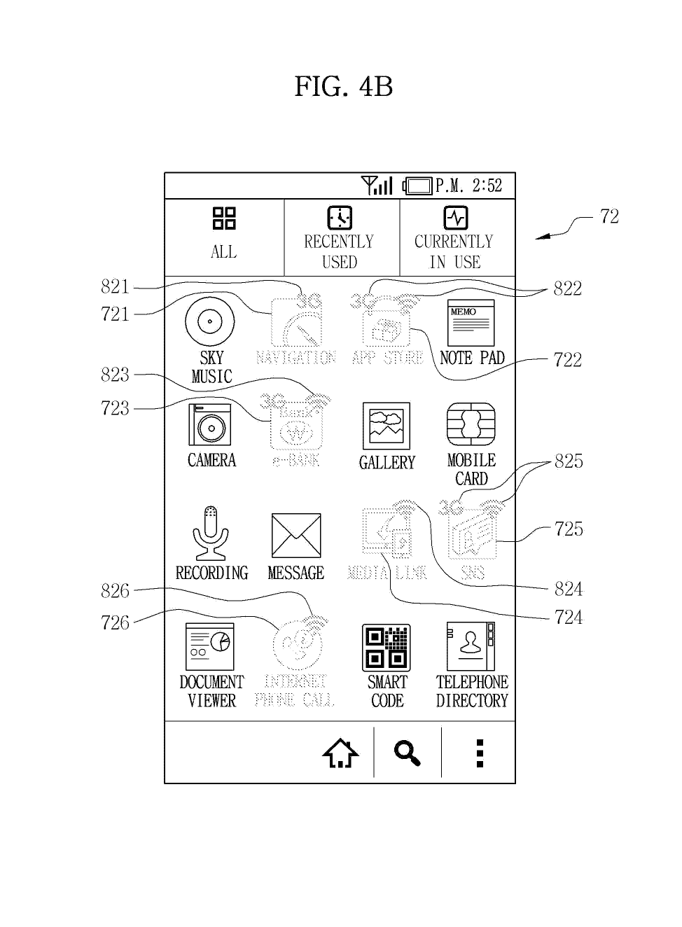

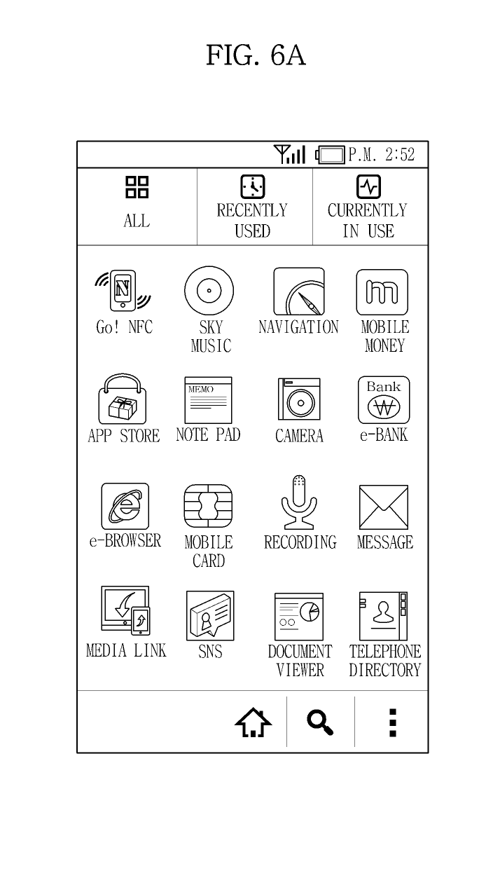

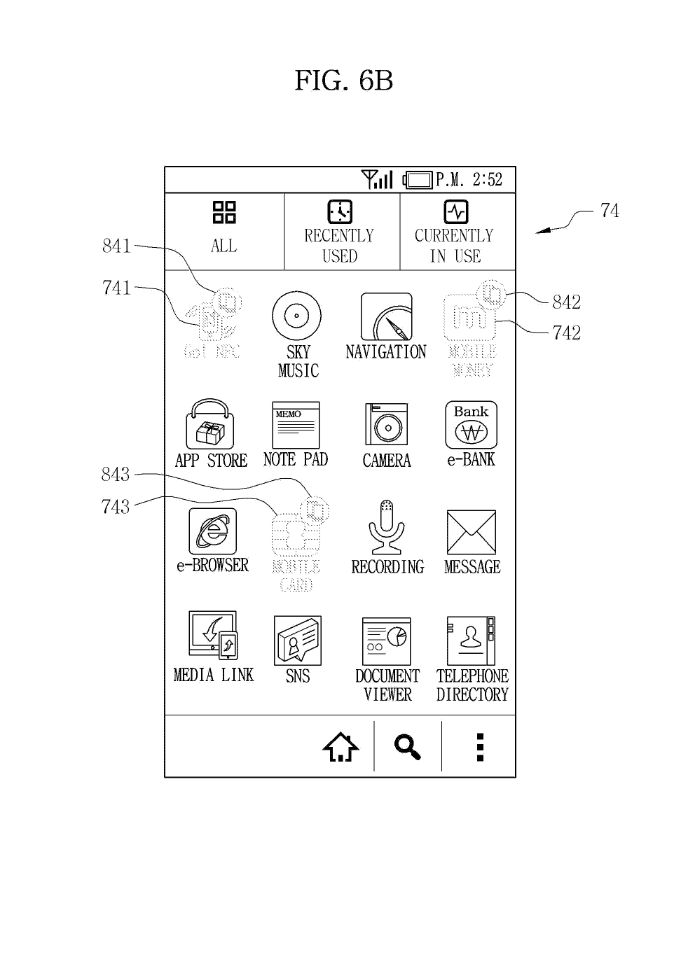

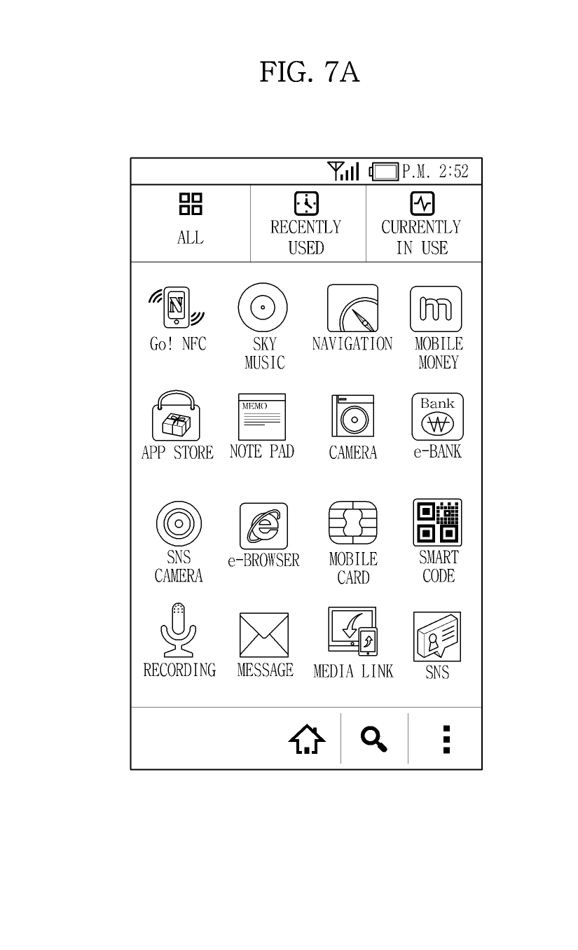

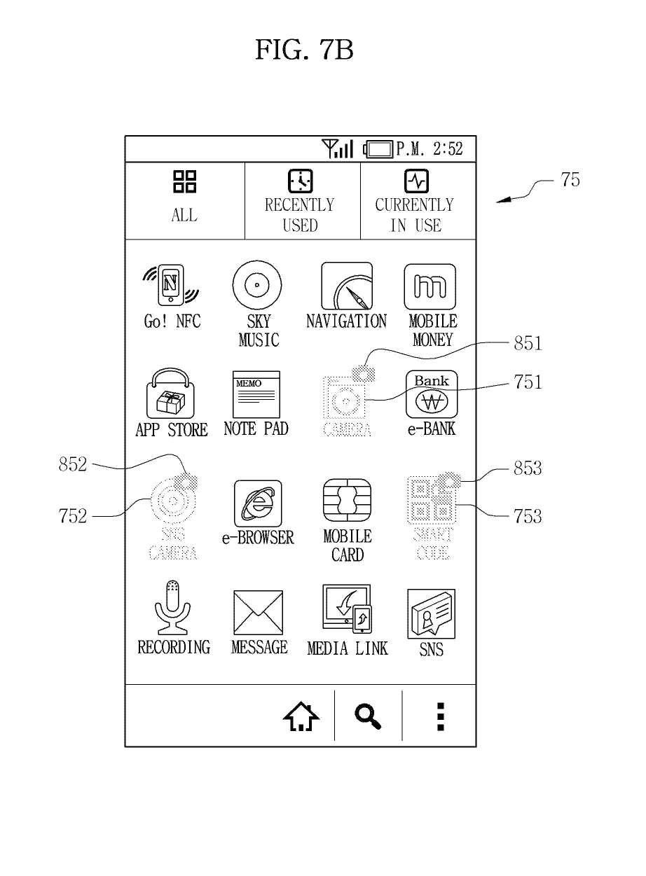

FIG. 4B, FIG. 5B, FIG. 6B, FIG. 7B, and FIG. 8B illustrate a screen displayed on a display unit of a terminal, according to exemplary embodiments of the present disclosure. Since a terminal described below is substantially the same as the terminal 1 illustrated in FIG. 1, description of the same constituent elements as illustrated in FIG. 1 will be simplified or not be presented.

FIGS. 4A and 4B illustrate examples of a case where the condition of the application relating to the use environments is a connection of a network such as a 3G/4G network or a WIFI network. In FIG. 4A, icons are uniformly arranged as a conventional case. On the other hand, referring to FIG. 4B, a screen 72 is illustrated in which the terminal 1 is not currently connected to a network, such as, a 3G/4G network or a WIFI network.

Accordingly, since the current state of the terminal 1 relating to the usage environment does not satisfy the precondition of the application relating to the usage environment, icons 721, 722, 723, 725, 724, 726 of applications that can be normally operated only in a case where the terminal is connected to a network such as a 3G/4G network or a WIFI network are processed to have a visual effect. Icons 721, 722, 723, 725, 724, 726 are exemplary visually affected icons as they have been dimmed.

In other words, the precondition of the applications corresponding to the icons 721, 722, 723, 725, 724, 726 relating to the usage environment is a connection of a network, such as, a 3G/4G network or a WIFI network.

The icons 721, 722, 723, 725, 724, 726 represent that the corresponding applications cannot be normally operated. In addition, auxiliary icons 821, 822, 823, 825, 824, 826 representing 3G/4G or WIFI may be displayed together with the icons 721, 722, 723, 725, 724, 726. The combination of icons 721, 722, 723, 725, 724, 726 with auxiliary icons 821, 822, 823, 825, 824, 826 illustrates exemplary visually affected icons that include the visual effect of dimming and addition of auxiliary icons.

Referring to FIG. 5A, icons are uniformly arranged according to various embodiments displaying a screen. The screen may be similar to a conventional screen displaying regular icons when a WIFI is available or connected. On the other hand, referring to FIG. 5B, a screen 73 is illustrated in which the terminal 1 is not connected to a WIFI network.

Accordingly, since the current state of the terminal 1 relating to the usage environment does not satisfy the precondition of the application relating to the usage environment, icons 731, 732 of applications that can be normally operated only in a case where the terminal is connected to a WIFI network are processed to have a visual effect. In other words, the precondition of the applications corresponding to the icons 731, 732 relating to the usage environment is a connection of a WIFI network. Icons 731, 732 are exemplary visually affected icons as they have been dimmed.

The above-described icons 731, 732 represent that the corresponding applications cannot be normally operated. In addition, auxiliary icons 831, 832 representing WIFI may be displayed together with the icons 731, 732.

FIGS. 6A and 6B illustrate examples of a case where the condition of the application relating to the use environments is a connection of NFC.

Referring to FIG. 6A, icons are uniformly arranged according to various embodiments displaying a screen. The screen may be similar to a conventional screen displaying regular icons when NFC is available or connected. On the other hand, referring to FIG. 6B, a screen 74 is illustrated in which the terminal 1 currently does not satisfy the NFC environment.

Accordingly, since the current state of the terminal 1 relating to the usage environment does not satisfy the precondition of the application relating to the usage environment, icons 741, 742, 743 of applications that can be normally operated only under the NFC environment are processed to have a visual effect. In other words, the precondition of the applications corresponding to the icons 741, 742, 743 relating to the usage environment is the NFC environment.

The above-described icons 741, 742, 743 represent that the corresponding applications cannot be normally operated. In addition, auxiliary icons 841, 842, 843 representing NFC may be displayed together with the icons 741, 742, 743.

FIGS. 7A and 7B illustrate examples of a case where the condition of the application relating to the use environments is the activated state of the camera.

Referring to FIG. 7A, icons are uniformly arranged according to various embodiments displaying a screen. The screen may be similar to a conventional screen displaying regular icons when a camera is available or active. On the other hand, referring to FIG. 7B, a screen 75 is illustrated in which the camera is currently inactive.

Accordingly, since the current state of the terminal 1 relating to the usage environment does not satisfy the precondition of the application relating to the usage environment, icons 751, 752, 753 of applications that can be normally operated only in a case where the camera can be used are processed to have a visual effect. In other words, the precondition of the applications corresponding to the icons 751, 752, 753 relating to the usage environment is an environment in which the camera can be used.

The above-described icons 751, 752, 753 represent that the corresponding applications cannot be normally operated. In addition, auxiliary icons 851, 852, 853 representing the camera may be displayed together with the icons 751, 752, 753.

FIGS. 8A and 8B illustrate examples of a case where the condition of the application relating to the use environments is a connection of Bluetooth.

Referring to FIG. 8A, icons are uniformly arranged according to various embodiments displaying a screen. The screen may be similar to a conventional screen displaying regular icons when a BLUETOOTH is available or connected. On the other hand, referring to FIG. 8B, a screen 76 is illustrated in which the terminal 1 cannot perform BLUETOOTH communication as a case according to the present disclosure.

Accordingly, since the current state of the terminal 1 relating to the usage environment does not satisfy the precondition of the application relating to the usage environment, an icon 761 of the application that can be normally operated only in a case where the BLUETOOTH communication can be performed is processed to have a visual effect. In other words, the precondition of the application corresponding to the icon 761 relating to the usage environment is an environment in which BLUETOOTH can be used.

The above-described icon 761 represents that the corresponding application cannot be normally operated. In addition, an auxiliary icon 861 representing BLUETOOTH may be displayed together with the icon 761.

As described above, a user can recognize whether applications corresponding to the icons can be normally operated. In addition, the user can immediately recognize the preconditions of the applications, which cannot be normally operated, relating to the usage environment and can change the setting of the usage environment of the terminal in accordance with the preconditions.

In a conventional technology, it can be recognized that the application cannot be normally operated only after the application is directly executed, and then, the usage environment is changed. According to the present disclosure, the usage environment can be easily checked to determine whether the applications can be normally operated before the execution of the applications, and the setting of the usage environment of the terminal can be changed, whereby a user's unnecessary operation can be reduced. Therefore, the time and the effort required for the user can be reduced, and the user convenience can be improved.

The present disclosure can be variously applied. For example, in a case where an update of an application is necessary, a visual effect can be applied to the icon of the application, and accordingly, a user can easily check a necessary update.

In a conventional technology, since update information is supplied through a notification manager, an update information notification is frequently displayed in the upper end of the display unit of the terminal. Accordingly, there is inconvenience that the information notification is continuously exposed before a user performs a corresponding update or checks and removes the information notification.

According to the present disclosure, in a case where an update is necessary or available, the necessity or availability of the update can be displayed in the icon, for example, by using an auxiliary icon with the corresponding application's icon, whereby a user can easily check the update status.

In addition, the present disclosure can be variously utilized, for example, by applying a visual effect to icons based on the use frequency of the applications, activation of an inflight mode of the terminal, the battery capacity, and installation/uninstallation of a Universal Subscriber Identity Module (USIM) chip, a Subscriber Identity Module (SIM) chip, and the like.

Although a few exemplary embodiments of the present invention have been shown and described, the present invention is not limited to the described exemplary embodiments. Instead, it will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal that displays the operability of an application, the terminal comprising:
a storage unit configured to store precondition information of the application relating to a usage environment;
a determination unit configured to compare the stored precondition information of the application to a current state information of the terminal, configured to determine whether the application is normally operable, and configured to apply a visual effect based on the determination to an icon corresponding to the application; and
a display unit configured to display the visually affected icon.

2. The terminal of claim 1, wherein the visually affected icon comprises combining an auxiliary icon with the icon for representing the precondition information of the application.

3. The terminal of claim 1, further comprising an environment setting unit configured to change a setting of the usage environment of the terminal in accordance with the precondition information.

4. The terminal of claim 1, wherein the visual effect comprises a representation conveying availability of an application update.

5. The terminal of claim 1, wherein the visual effect comprises a representation conveying a use frequency of the application.

6. The terminal of claim 1, wherein the precondition information comprises a plurality of preconditions and the visual effect comprises a plurality of representations conveying information about one or more of the plurality of preconditions.

7. The terminal of claim 1, wherein the visual effect comprises a representation conveying availability of at least one of a communication network selected from at least one of a 3G network, a 4G network, a WIFI network, a Near Field Communication (NFC) network, and a BLUETOOTH network.

8. The terminal of claim 1, wherein the visual effect comprises a representation selected from at least one of availability of a camera, activation of an inflight mode of the terminal, battery capacity, installation of a Universal Subscriber Identity Module (USIM) chip, and installation of a Subscriber Identity Module (SIM) chip.

9. The terminal of claim 1, wherein the visual effect comprises a visual effect comprising at least one of using a dimming, using a monochromatic palette, using a sharpness adjustment, using a transparency adjustment, using a web process, using a mosaic process, and using an auxiliary icon.

10. A method for displaying the operability of an application, the method comprising:
storing precondition information of the application relating to a usage environment;
comparing the stored precondition information of the application to a current state information of the terminal;
determining whether the application is normally operable;
applying a visual effect based on the determination to an icon corresponding to the application; and
displaying the visually affected icon.

11. The method of claim 10, wherein the visually affected icon comprises combining an auxiliary icon with the icon for representing the precondition information of the application.

12. The method of claim 10, further comprising changing a setting of the usage environment of the terminal in accordance with the precondition information.

13. The method of claim 10, wherein the visual effect comprises a representation conveying availability of an application update.

14. The method of claim 10, wherein the visual effect comprises a representation conveying a use frequency of the application.

15. The method of claim 10, wherein the precondition information comprises a plurality of preconditions and the visual effect comprises a plurality of representations conveying information about one or more of the plurality of preconditions.

16. The method of claim 10, wherein the visual effect comprises a representation conveying availability of at least one of a communication network selected from at least one of a 3G network, a 4G network, a WIFI network, a Near Field Communication (NFC) network, and a BLUETOOTH network.

17. The method of claim 10, wherein the visual effect comprises a representation selected from at least one of availability of a camera, activation of an inflight mode of the terminal, battery capacity, installation of a Universal Subscriber Identity Module (USIM) chip, and installation of a Subscriber Identity Module (SIM) chip.

18. The method of claim 10, wherein the visual effect comprises a visual effect selected from one or more using a dimming, using a monochromatic palette, using a sharpness adjustment, using a transparency adjustment, using a web process, using a mosaic process, and using an auxiliary icon.

19. A computer-implemented method to display the operability of an application, the method comprising:
storing, in a non-transitory storage, an operating environment precondition of the application;
comparing, with a processor, a current operating environment of a terminal with the operating environment precondition to determine the operating environment precondition that is unsatisfied by the current operating environment;
selecting a visual effect to represent the unsatisfied operating environment precondition;
applying the visual effect to an icon corresponding to the application; and
displaying, with processor, the visually affected icon.

20. The method of claim 19, wherein the visual effect comprises an auxiliary icon overlaying the icon.
